(19) United States
(12) Patent Application Publication
(10) Pub. No.: US 2009/0191853 A1
(43) Pub. Date: Jul. 30, 2009

(54) TELEPHONIC SYSTEM OF AGGREGATING MULTIPLE ADVERTISERS OR PRODUCTS WITHIN AN ON-DEMAND CONSUMER-ACCESSIBLE DATABASE AND METHOD THEREOF

(75) Inventor: Steven Van Praagh, Oradell, NJ (US)

Correspondence Address: PRYOR CASHMAN, LLP, 410 PARK AVENUE, NEW YORK, NY, 10022, US

(73) Assignee: TRUPING LLC, New York, NY (US)

(21) Appl. No.: 12/256,589

(22) Filed: Oct. 23, 2008

Related U.S. Application Data
(60) Provisional application No. 61/024,223, filed on Jan. 29, 2008.

(51) Int. Cl. H04W 4/00

(52) U.S. Cl. 455/414.3

(57) ABSTRACT

A telephonic system of providing information about aggregated advertising, products, and services includes a plurality of publicly detectable advertisements each having a different code. A central telephony system receives the associated codes from a consumer via a mobile telecommunications device (e.g., phone) upon the consumer becoming aware of the code. A message transaction is created and recorded, and a message is sent to the consumer's mobile phone in response to the code entered by the consumer being recognized by the central telephony system; the message corresponds to the entered code. Software is downloadable to the consumer's mobile phone and is adapted to program the consumer's mobile phone with a telephone access number for the central telephony system. Each advertiser can control how and to whom a message is sent via its message profile, and each consumer can control how and from whom a message is received via his/her profile.

### RELATED APPLICATIONS

Domestic priority is claimed from U.S. Provisional Patent Application No. 61/024,223, filed Jan. 29, 2008, entitled “Advertising Requests”, the entirety of which is incorporated by reference herein.

### BACKGROUND OF THE INVENTION

1. Field of the Invention

The invention generally relates to mobile communications systems and features thereof, such as text messaging. The invention additionally relates to advertising media; more particularly, the invention relates to automated systems that enable consumers to retrieve information immediately upon seeing or hearing an advertisement for a product or service that appeals to them, or a message or announcement of importance, or immediately upon thinking of a product, service, or the like even without having seen or heard an ad for same.

2. Description of Related Art

Public advertising, be it visual, such as billboards, television commercials, and the like, or aural, such as radio announcements, or a combination of both (e.g., people handing out flyers on a street corner or in a stadium) has been in existence for decades, if not centuries. The chief purpose of public advertising is to alert consumers that a product or service exists and to extol the virtues of same. Public announcements are also made for purposes of spreading messages of importance (e.g., missing child, traffic conditions, etc.). Businesses and governments spend billions of dollars annually on advertising and otherwise disseminating information (hereinafter “advertising”). Yet, the effectiveness of a particular advertisement is rarely understood, let alone quantified.

Many advertisements include a telephone number or an internet URL for a consumer to contact for more information about the advertised product or service. However, this process is not ideal and is fraught with inefficiencies. For one, a person may not have the time or ability to dial a ten digit phone number or type an even longer web address into a mobile telecommunications device (cell phone, PDA, smart phone, etc.) immediately upon seeing an advertisement when his interest is at its peak. For example, if the person is driving or even walking on a street, diverting his attention from driving or walking to enter a ten digit phone number (and typically press “SEND” or the like) on a mobile telephone is liable to cause a vehicular or pedestrian accident. Further, even if the potential purchaser has the wherewithal to enter the correct telephone number successfully and safely, the result is a telephone call to a human operator who must input their information, or worse: an automated information system requiring menu navigation and additional button pressing. Many consumers, even if initially interested in a product or service, simply cannot be bothered to maintain their interest throughout this process. Arriving at a website via a browser eliminates some of the problems of suffering human interaction, however a consumer on the go cannot reasonably be expected to stop and look at a website to request information or purchase a product; she typically must wait until she arrives at home, her office, an internet cafe, or other place with a computer terminal.

A consumer viewing a television advertisement at home at least has the ability to go to her land line (or her mobile phone if she does not have a land line) and endure the process outlined above, since she is not en route somewhere and can devote a few minutes of time otherwise spent at home to the information request. Not so with advertisements on public display, and not so for television advertisements viewed in a public place (e.g., a bar, a store window, an airport, etc.).

From the advertisers' perspective, the conventional method of providing a telephone number in connection with a public advertisement is far from perfect. Since consumers do not typically drop what they are doing to request information about an advertised product, advertisers must hope that their ads make enough of an impression to register and resonate with a consumer long after the consumer is out of visual/aural range of the ad. Also, if an advertiser is running multiple versions of an ad (print media, TV, radio, billboard, etc.) in multiple locations, the advertiser may not know which medium or location is most effective in piquing the consumer's interest. For ads soliciting a telephone call, operating a call center requires a significant amount of capital and oversight to ensure quality representation of the product and the advertiser. For ads soliciting a visit to a website, the website must be visually appealing and properly maintained.

There have been some attempts in the telecommunications art to solve these problems, with mixed results at best. One such attempt is known in the industry as short codes or Common Short Codes. Short codes require a two-part transaction on the part of the mobile user: first, the user must enter a number approximately 5-6 digits in length, and then the user must enter a short text message and/or series of numbers and send the message to the entered number. By incorporating text along with numbers, this process is arguably even more difficult for a mobile user on the go than straight telephone number dialing; it is clearly dangerous to do while driving. Additionally, short codes may be limited to specific wireless service providers; those with a different provider seeing the short code may not be able to avail themselves of the information at all. Content providers (e.g., advertisers, product sellers) need to obtain approval from each wireless service provider to be able to deliver messages to the service providers' subscribers; as such, the service provider ultimately holds the power to control what content is approved or not. Additionally, upon receipt of the first transmission from the content provider, mobile phone users must confirm that they wish to continue and must opt-in further to continue the transaction. Mobile phone users must suffer this process for each short code they use.

Other attempts in the field include a variety of services which require the user to take a picture with a camera phone (e.g., of a bar code or other image) and send it to the information provider, an inherently limited process. For one, such an activity is impossible for the consumer on the go, as one must stand very still to take a reasonably clear photograph. It is difficult to take a good photograph on a cell phone even when trying to pose a friend or capture a landscape, let alone scan a bar code. Even assuming the consumer wants to stop and take the requisite snapshot, environmental factors may prevent the capture of a usable image; for example, it may be too dark outside, or the consumer cannot get close enough to or far enough from the image, or the image is dirty or covered in graffiti, or the like. Even if conditions are ideal, the image might simply remain unrecognized by the system. Entities attempting such processes include: Mobile Discovery of Reston, Va.; SnapTell of Palo Alto, Calif.

An audio version of this type of process is being attempted as MyQuu by Emo-V, Inc. of Mercer Island, Wash., in which the user must sample an audio signal (e.g., a song, an advertisement, etc.) via a specific piece of hardware. A copy of or information about the sampled audio is stored in an online account for future access. This has the drawback of suffering from audio recognition (e.g., it will not work with a lot of background noise), and it does not provide the consumer with information immediately at his fingertips. Further, this is solely for audio content and wholly inapplicable to visual advertisements such as billboards. A similar system is being marketed by HipCricket of Kirkland, Wash.

In short, there is a long-felt need of enabling consumers who are on the go and happen to see or hear an advertisement that piques their curiosity—or see or think of a product or service itself—to retrieve information about the advertised product/service with a minimal amount of data entry and thus with minimal interference with other activities such as walking or driving. Relatedly, there is a long-felt need for advertisers to be able to send consumers information about a product in an on-demand basis, that is, precisely when the consumer sees or hears an ad and has the requisite interest. Finally, more accurate means of determining advertising effectiveness are also desired.

### SUMMARY OF THE INVENTION

The invention includes a system and method of providing on-demand information relating to aggregated publicly detectable advertising over a mobile telecommunications network. In one embodiment, the inventive system includes a plurality of different publicly detectable advertisements each having a different code or keyword (hereinafter “code”) associated therewith. A central telephony system is provided to receive entry of the associated codes by a consumer via a mobile telecommunications device upon the consumer becoming aware of the associated code. The consumers enter the code by speaking or entering it on the keypad of the consumer's mobile device. At least one computer is in communication with the central telephony system and is adapted to create a message transaction and send a message to the consumer's mobile telecommunications device and/or to an e-mail address or another device (e.g., a fax machine) in response to the code entered by the consumer being recognized by the central telephony system. The message sent to the consumer corresponds to the entered code.

Preferably, the plurality of advertisements represent different advertisers each associated with and subscribing to the inventive system. In addition or in the alternative, one advertiser may have a number of different advertisements each with a different associated code as part of the system. This would allow the advertiser to measure the effectiveness of advertising more accurately based on differences among the ads, their locations, etc.

The system preferably further includes software resident on the at least one computer which is downloadable to the consumer's mobile telecommunications device. The software preferably has an embedded link and programs the consumer's mobile telecommunications device with a telephone access number for the central telephony system when the embedded link is activated (similar to “click-to-call dialing”). In a preferred embodiment, the software programs the “zero” button as a speed-dial for the system telephone access number. In another embodiment, the software programs one of the consumer's mobile telecommunications device's speed-dial positions (optionally, a consumer-selected speed-dial position) with the telephone access number.

The at least one computer of the system preferably includes at least one database, including a transaction database in which the message transactions are recorded. Each of the message transactions includes but is not limited to data fields such as: which advertisement triggered the message transaction; type of advertisement; personal information about the consumer who entered the code; time of day of the message transaction; other codes the consumer previously entered; location of consumer when the code was entered; and others.

A plurality of message profiles is preferably resident on the system's at least one computer. The message profiles contain message instructions each corresponding to respective of the codes enterable into the central telephony system, the message instructions concerning how the messages are sent to consumers' mobile telecommunications devices. The message instructions include at least one of: content of the message; limiting a time period during which the message may be sent; limiting to which consumers the message may be sent based on a consumer demographic parameter; and the like. For example, an advertiser may set a Valentine's Day message to be sendable on February 14, but at midnight on February 15, the message would change to a non-Valentine's Day promotion. Similarly, one message may be sent to a person of one value of a given demographic parameter (e.g., under 35 years old, earns less than $100,000/year, etc.), while a different message may be sent to another person making the same informational request having a different value of a given demographic parameter (e.g., over 35 years old, earns more than $100,000/year, etc.). Multiple parameters may be used to determine which, if any, message a consumer receives. A remote interface is preferably provided to enable advertisers to each remotely configure or modify its respective message profile. The system may further include an advertiser management database upon which the message profiles reside, the advertiser management database being accessible by the advertisers via the remote interface. At least one messaging server may be provided in communication with the advertiser management database. The messaging server forwards messages to consumers' telecommunications devices in response to receipt of the codes by the central telephony system from the consumer's telecommunications device.

The plurality of different publicly detectable advertisements may include a first plurality of a first advertisement and a second plurality of a second advertisement, wherein each of the first advertisements has a same first code associated therewith and each of the second advertisements has a same second code associated therewith. That is, multiple instances of the same advertisement will preferably have the same code, while different advertisements from the same advertiser may be provided with different codes.

Preferably, a plurality of consumer-configurable profiles are resident on the at least one computer, each of the consumer-configurable profiles containing message instructions concerning how the messages are to be sent to the respective consumers. Those message instructions preferably include at least one of i) to which of a plurality of communication devices the consumer is instructing the system to send the messages; ii) restricting receipt of the messages based on message content restrictions; iii) message format restrictions; iv) whitelisting certain advertisers; v) blacklisting certain advertisers; or vi) restricting receipt of the messages based on respective advertiser demographic parameters. The plurality of consumer communication devices includes at least one of a cell phone, a fax machine, an e-mail account, or on a consumer's page or account on one or more social networking sites. Optionally, any messages sent to a consumer's social networking page or account can also be subscribed to by or forwarded to other members of the same social networking site via micro-blogging (e.g., Steve gets a message from Facebook every time Jane requests and receives information from the inventive system).

The system further preferably includes a registration database upon which the consumer-configurable profiles reside, and a remote interface adapted to enable the consumers to each remotely configure or modify his/her respective consumer-configurable profile. At least one of the consumer-configurable profiles corresponds to each of the consumers.

The invention also includes a telephonic method of telephonically providing on-demand information relating to aggregated publicly detectable advertising via a mobile communications network. For a plurality of different publicly detectable advertisements, a different code is associated with each advertisement. This feature can be used not only for conventional advertising purposes (i.e., dissemination of information), but it also can be used to turn the public into a large focus group to test market different yet similar ideas to see which is more effective and which delivers better return on investment. A central telephony system is provided responsive to the entry of the associated codes by a consumer via a mobile telecommunications device upon the consumer becoming aware of the associated code. A message transaction is created by sending a text or voice message to the consumer's mobile telecommunications device (and/or to a designated e-mail account provided by the consumer upon joining as a member of the system), in response to the code entered by the consumer being recognized by the central telephony system, the message corresponding to the advertisement bearing the entered code.

The plurality of advertisements may represent different advertisers. The code may be associated with the advertisement by either displaying the code on or near an advertisement or generating an audible version of the code in association with an advertisement.

The message sending step may further include the step of sending a text or voice message to the mobile telecommunications device that sent the corresponding recognized code to the central telephony system (and/or to another device designated by the consumer).

Preferably, a telephone access number is provided for consumers to access the central telephony system and thereby enter a code, and the inventive system preferably includes the step of automatically programming a consumer's mobile telecommunications device with the telephone access number in response to a consumer-initiated action. The automatic programming step may further include the steps of sending a text message to the mobile telecommunications device with an embedded link and downloading and executing an applet that programs the mobile telecommunications device with the telephone access number when the embedded link is activated. The automatic programming step may include the step of programming one of the mobile telecommunications device's speed-dial positions with the telephone access number via the applet. The consumer may be allowed to select which speed-dial position is programmed with the telephone access number.

The consumer-initiated action may include the step of initially calling the telephone access number via the consumer's mobile telecommunications device. Alternatively, the consumer-initiated action may include the step of requesting the text message with the embedded link via an internet-based interface.

Each message transaction is preferably recorded in a transaction database; each recorded message transaction includes at least which advertisement triggered the transaction. The transaction recording step includes the step of recording at least one of: which advertisement triggered the transaction; personal information about the consumer who provided the code; time of day of the transaction; location of consumer when the code was provided; and/or other information.

In the inventive method, the advertisers are preferably each able to remotely configure or modify a message profile which contains message instructions corresponding to each respective code enterable into the central telephony system. The message profiles are storable on a computer in communication with the central telephony system and include instructions concerning the step of sending messages to the consumers' mobile telecommunications devices. The message profile instructions preferably include at least one of: message content; limiting a time period during which a message may be sent; limiting to which consumers a message may be sent based on a consumer demographic parameter, and other data.

The inventive method preferably further includes the steps of enabling the consumers to each remotely configure or modify a message profile which contains message routing instructions. The message profiles are storable on a computer in communication with the central telephony system. The message profiles include instructions concerning the step of sending messages to the consumers' mobile telecommunications devices, such instructions including at least one of: of i) to which of a plurality of communication devices the consumer is instructing the system to send the messages; ii) restricting receipt of the messages based on message content restrictions; iii) message format restrictions; iv) whitelisting certain advertisers; v) blacklisting certain advertisers; or vi) restricting receipt of the messages based on respective advertiser demographic parameters, such as brand, product, color, or other preferences.

In another embodiment, the invention is not limited to requiring a consumer to actually see or hear an advertisement with a concomitant ad code. Rather, the invention also has an optional aspect of enabling a consumer to call into to the system to request information about a subscribing seller's consumer product or service. In this embodiment, the invention is a telephonic system of providing on-demand information relating to aggregated product branding over a mobile telecommunications network. A plurality of different consumer products or services each has a different code associated therewith. A central telephony system is adapted to receive entry of the associated codes by a consumer via a mobile telecommunications device upon the consumer becoming aware of the associated code. At least one computer is provided in communication with the central telephony system adapted to create a message transaction and send a message to the consumer's mobile telecommunications device in response to the code entered by the consumer being recognized by the central telephony system, the message corresponding to the entered code. The codes may include at least one of i) the respective names of the consumer products or services (e.g., “Ford” or “McDonald's”), or ii) respective generic words describing the consumer products or services (e.g., “car dealer” or “burger”).

Similarly, this embodiment of the invention also includes a telephonic method of telephonically providing on-demand information relating to aggregated product branding via a mobile communications network. The following steps are included in this aspect of the invention. For a plurality of different consumer products or services, a different code with each product or service is associated. A central telephony system is provided responsive to the entry of the associated codes by a consumer via a mobile telecommunications device upon the consumer desiring information concerning a product or service. A message transaction is created by sending a message to the consumer's mobile telecommunications device in response to the code entered by the consumer being recognized by the central telephony system, the message corresponding to the product or service associated with the entered code. The codes may include at least one of i) the respective names of the consumer products or services, or ii) respective generic words describing the consumer products or services, as noted above.

The inventive system and method enables a consumer to say or enter a code, keyword, brand name, or even a descriptive noun to the telephonic system and retrieve information instantly about the desired product or service. Subscribing advertisers or sellers of the products or services are able to control the contents of the message and even to whom, to where, and when the message will be made available at all. The system is a dual-opt-in system for both consumer and seller/advertiser, thereby eliminating unwanted ads going to an irritated consumer, while making potentially vast amounts of information available to a desirous consumer in an exceedingly efficient and cost-effective manner.

### BRIEF DESCRIPTION OF THE DRAWINGS

FIG. 1 is an overall schematic of a system of aggregating multiple advertisers within an on-demand telephonic consumer-accessible database in accordance with the invention.

FIG. 2 is a schematic of a variety of different advertisements and corresponding associated codes in accordance with the invention.

FIGS. 3A-B are flow charts of a method of telephonically providing on-demand information relating to aggregated publicly detectable advertising via a mobile communications network in accordance with the invention.

FIG. 4 is a flow chart of a preferred subset of instructions of the inventive method concerning consumer-configured message routing instructions.

FIG. 5 is a flow chart of another preferred subset of instructions of the inventive method concerning consumer-configured message routing instructions.

### DETAILED DESCRIPTION OF THE INVENTION AND DRAWINGS

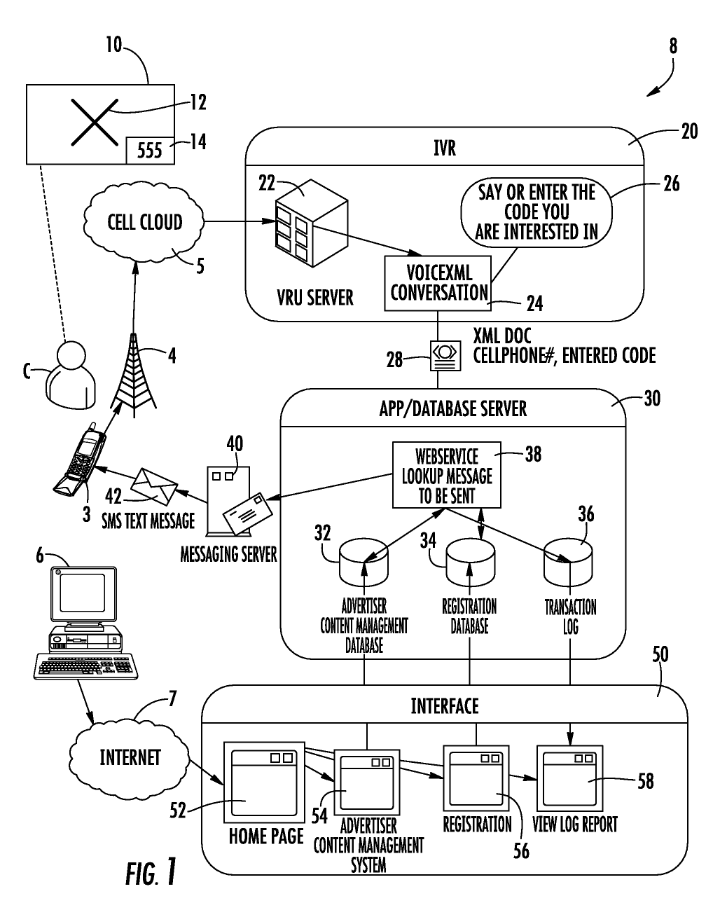

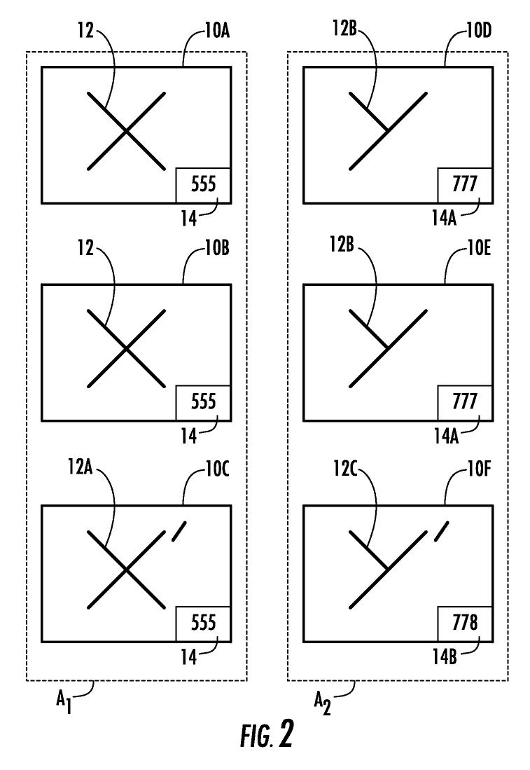

Description of the invention will now be given with reference to FIGS. 1-5. It should be understood that these figures are exemplary in nature and in no way serve to limit the scope of the invention, which is defined by the claims appearing hereinbelow.

As described above, it is often difficult for a consumer to obtain on-demand information about a product or service being publicly advertised at the moment when the consumer views or hears the advertisement, or at the moment the consumer sees or thinks about a product or service. By use of the inventive system and method, on-demand information is available to the consumer via her mobile communication device (hereinafter mobile phone; however, this term contemplates any mobile communication device known now or to be developed later).

System 8 is shown in overview in FIG. 1. The system includes one or more publicly detectable advertisements 10 having a message 12. Advertisements 10 may be visual and may take the form of a billboard, a bus stop ad, a newspaper or magazine ad, a subway station ad, a television commercial, or an internet ad (banner or otherwise). Additionally or in the alternative, the advertisement may be aural in nature, e.g., a radio commercial, a television commercial, a movie, a podcast, a video game, or an internet ad. Combinations of aural and visual information (e.g., a poster with a button which, when pressed, causes an audio message to be played) are also contemplated. In fact, the inventive system is designed to work with essentially any form of public advertising known now or to be developed later.

Associated with every advertisement 10 in system 8 is an ad code 14, preferably a short (e.g., 1-4 digits or characters) numeric or alphanumeric code that is visible alongside a visual ad or audible in connection with an aural ad (or both where appropriate). Ad code 14 provides the consumer C with an easy and quick way to retrieve additional information about a product or service displayed in an advertisement. The consumer C sees/hears advertisement 10, calls into system 8 via his mobile phone 3 (such call being routed through a local cellular tower 4 and through the cell cloud 5) and reaches interactive voice response unit (IVR) 20 of system 8.

IVR 20 includes a server 22 having software 24 resident thereon. Voice prompts 26 are included as part of IVR 20. IVR 20 functions in the manner of a conventional IVR.

When consumer/caller C contacts system 8 (e.g., by dialing a telephone number associated with the system) and reaches IVR 20, software 24 prompts the caller to supply the ad code 14 corresponding to the ad about which the caller is calling. Each ad code 14 is designed to trigger a text or similar message to be transmitted to the mobile phone that made the request, as described below.

When the caller enters the ad code 14 into mobile phone 3 to thereby transmit the code to IVR 20, IVR 20 receives same and creates an XML (or similar) document 28 which includes at least the phone number of the mobile phone requesting the information and the entered ad code. XML document 28 may also include a time/date stamp, a geographical location (determinable, e.g., by which cell tower 4 routed the call), information about the caller's phone service provider, and the like.

IVR 20 transmits XML document 28 to application/database server 30. Server 30 includes at least one database, but preferably includes an advertiser content management database 32, a registration database 34, and a transaction log 36. (Although these databases are shown as separate items in FIG. 1, they may all reside on the same device, and indeed, may all be inter-related, e.g., as fields in one or more tables.) Advertiser content management database 32 preferably stores message profiles, configured by the advertisers, which contain message instructions concerning how the messages are sent to consumers' mobile telecommunications devices. The message instructions include at least one of: content of the message; limiting a time period during which the message may be sent; limiting to which consumers the message may be sent based on a consumer demographic parameter; limiting a message to a certain geographical location (either by area code of the caller's number, or the cell tower used, or other means); and the like.

Registration database 34 stores demographic information about the consumers who register their mobile phones with system 8 (e.g., via computer 6 over the internet 7). When the consumer/caller registers with system 8, she is preferably able to create her own messaging profile which provides the system with instructions as to what messages she is interested, in what format they should be sent, and/or to which device or devices. Regarding content, the caller or consumer is able to blacklist or whitelist specific advertisers, and is able to block (or request) specific genres of messages. For example, a parent can block a message on a child's phone regarding tobacco, alcohol, video games, candy, etc.). Indeed, the caller herself may wish to avoid receiving messages from certain advertisers despite having personally entered an advertising code; sometimes, it is not clear from the advertisement itself what the advertisement is about or who the advertiser is behind it. Similarly to the advertiser's profile, the consumer's profile may also screen out possible advertisers based on the advertiser's demographic parameters. For example, a consumer may wish to receive messages only from luxury brand or “high end” companies. A consumer can also opt to have messages sent either as voice or text to her mobile phone and/or to other devices, such as a fax machine, an e-mail account, or they can appear on the consumer's social networking page/account and be actively transmitted or passively made available to other members of the social network via micro-blogging. The consumer can also change the format of a message: e.g., voice or text to a mobile phone; HTML, rich, or plain text (and with or without graphical or video content) to the e-mail account; and the like.

Consumers may remotely access the system via interface 50 to set up, configure, and modify their respective profiles on registration database 34. After logging onto home page 52, consumers can remotely manage their profiles stored in database 34 via consumer registration page 56. There, the consumer can change any or all of the parameters concerning how a given message is to be received.

Transaction log 36 stores accounts of each message sent to each mobile phone for later study by advertisers vis-à-vis how effective an ad campaign or medium is in piquing consumer interest, and any other data sought to be examined. Transactions stored in transaction log 36 include data fields such as: which advertisement triggered the message transaction; personal information about the consumer who entered the code; time of day of the message transaction; location of consumer when the code was entered; and others.

Upon receiving the XML document 28 from IVR 20, software 38 on server 30 determines which outgoing text message corresponds to the code entered by the caller by looking it up on advertiser content management database 32. Software 38 may also determine if the mobile phone making the request for information represents a demographically qualified caller. For example, the same ad code 14 may cause one message to be sent to a person of high income and a different message (or no message at all) to be sent to a person of low income. Should the caller qualify to receive a message, software 38 then contacts message server 40 and instructs it to send the relevant text message 42 to mobile phone 3. The caller may review the information at her leisure.

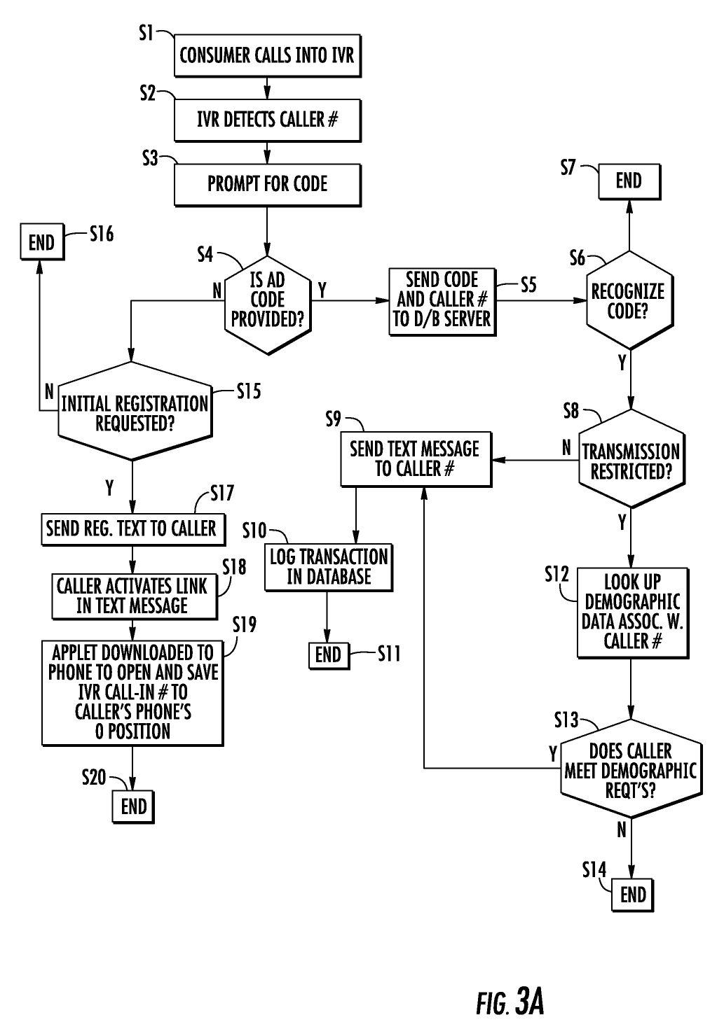

FIG. 1 shows one exemplary advertisement 10 bearing message 12 and concomitant ad code 14. The inventive system may be used by a single advertiser, however it is preferably a system for aggregating multiple advertisers and placing their messages within easy reach of the consumer on the go. FIG. 2 is a schematic of a plurality of advertisements 10A-F; advertisements 10A-C represent products/services of a first entity/advertiser A1, and advertisements 10D-F represent products/services of a second entity/advertiser A2. Although only two entities/advertisers are shown, the system is extremely scalable, limited only by the number of characters/digits desired in an ad code. For example, a three-digit ad code scheme would be limited to up to 1000 entities (0-9×three digits); a three-character alphanumeric code would be limited to up to 46,656 entities (A-Z and 0-9×three characters); etc. Much higher limits can be set if the system is configured to accept codes of different lengths (e.g., one-, two-, or three-digit codes).

Advertisements 10A and 10B bear identical messages 12 (X), and thus it is expected that both advertisements 10A and 10B will have the same ad code 14 (555) associated therewith. Advertisement 10C bears a slightly different message 12A (X′), which may represent either a different product or service offered by the same entity/advertiser A1, or it may represent a different ad campaign for the same product/service (e.g., “Coke is it” instead of “have a Coke and a smile”). In either case, advertisement 10C is optionally provided with the same ad code 14 (555) as advertisements 10A and B. In this configuration, any consumers seeing/hearing any of advertisements 10A-C will also see/hear the same ad code 14, and all entering such code 14 into system 8 will receive the same message 42 (demographics notwithstanding).

Another entity/advertiser A2 may have its own advertisements 10D-F with its own messages 12B and C and corresponding ad codes 14A and B. Advertisements 10D and E bear identical messages 12B (Y) and thus have the same ad code 14 (777), albeit a different code from ads 10A-C. Advertisement 10F has a slightly different message 12C (Y′) and, unlike the scheme of advertiser A1, advertisement 10F has a different ad code 14B (778). This is one way for advertiser A2 to determine which ad message (Y or Y′) is more effective. Advertisers may choose to provide different ad codes 14 for different geographical locations of the same advertisement, may choose to have different messages sent to consumers based on their zip code to test different offers in different locations, or they may rely instead on cell phone tower information to determine which advertisement piqued the consumer's interest.

The above aspects of the system, while complete on their own and which allow the advertiser the ability to provide (and track) information to consumers without staffing a call center or maintaining a website, still require the consumer to place a telephone call to the system in order to be able to enter the relevant ad code so that the desired text message may be sent and reviewed. As discussed, punching in a complete phone number while on the go is not an optimal way to request information. As such, the inventive system further contemplates that consumers can opt into the system in an easier manner.

One preferred manner of such an opt-in is to program the system access phone number of the system into a speed dial position on the consumer's phone. However, many phone users either do not use their speed dial function, know how to program it, or even know of its existence. It is also difficult to require much by way of action from the consumer in advance of her even seeing/hearing an ad, and there is a significant likelihood that the typical consumer will not want to be bothered or will enter the access number incorrectly.

In accordance with the inventive method, the consumer only needs to call into the system via its telephone number one initial time and enter a code or speak a keyword to activate a registration protocol. In response to such a registration call, instead of sending a text message with product information to the mobile phone, the system sends a message which includes a highlighted link. When the link is activated by the consumer, the system downloads an applet to be installed on the mobile phone which will program the system's call-in/access phone number into a speed dial position on the consumer's mobile phone. The applet initiates the launch of the mobile phone's contact list or “phone book”, in which one can store a phone number permanently as a speed dial. In doing so, the applet will either assign a speed-dial position or will ask the user to assign a speed-dial position that the applet will set to the system's access telephone number. Once the number is stored, the applet shuts down. Thereafter, when the consumer sees or hears an advertisement 10 bearing an ad code 14 and desires more information, she merely presses the programmed speed-dial button to access the system, and then when so prompted, she enters the relevant ad code of one to three digits or characters. The consumer will then receive information as a result of pushing as few as two buttons (or fewer, if the system includes speech recognition, which is within the scope of the invention) on his mobile phone.

So as to assist the consumer in remembering which speed dial setting she selected, when the consumer opts into the service, she may be presented with a card or a very small sticker to place on or near the selected button (assuming she selects a single digit speed dial position). As another way to assist the consumer in remembering which button accesses the system, the applet can simply program one button (e.g., the zero button, discussed below) of the phone with the system access number.

Although calling into the system for initial registration is preferred, an alternative method of registering would include visiting a website and entering one's mobile phone number. The system would then send the message with highlighted link to the entered mobile phone number, and the process would proceed as described above. As another less preferable alternative, one could write down and mail in one's mobile number, or one could tell a representative of the entity operating the system one's mobile number, and the message with highlighted link could be sent to the consumer's mobile phone. In any of the registration methods, the consumer is preferably asked to provide demographic data (e.g., gender, income, location, age, etc.) so that advertisers can track which segments of the population are interested in which of their products and services, and for other data determination purposes. Demographic data may also be used to screen out or restrict some messages from going to specific segments of the population (e.g., people living in one state may not be entitled to receive information about fireworks; people under the age of 21 may not be allowed to receive information about alcoholic beverages; an advertiser may be subject to a non-compete clause and thus forbidden to advertise to people in a certain region; etc.).

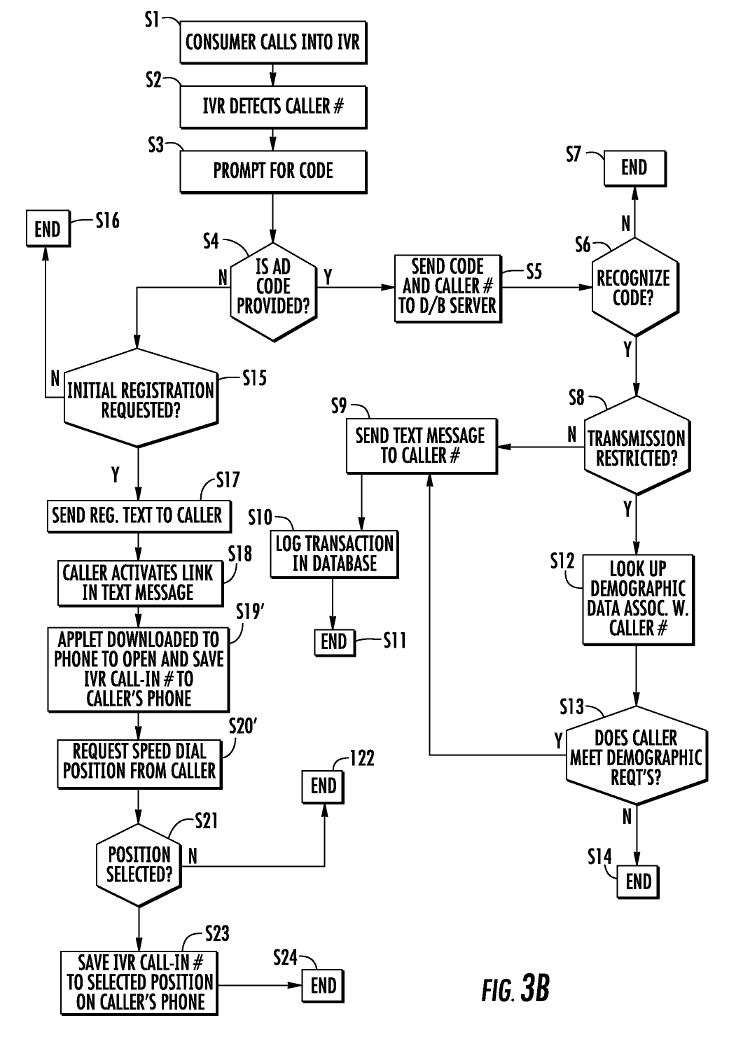

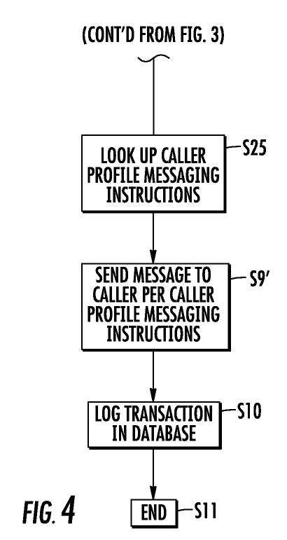

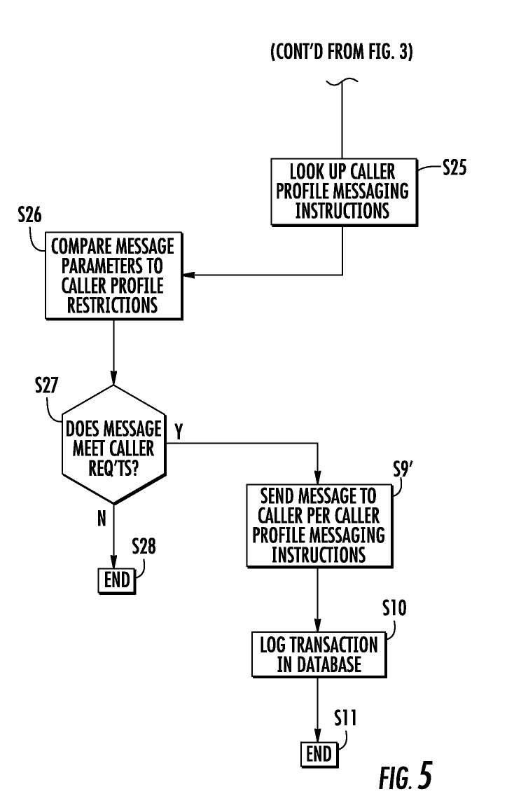

The overall operation of the inventive method is depicted in the flow charts of FIGS. 3A and B, with additional reference to the components of FIG. 1. The two logic flow charts of FIGS. 3A and B are very similar; FIG. 3A represents one preferred embodiment, and FIG. 3B represents an alternate embodiment. Since most of the steps are substantially identical, reference will be made once for common steps.

As shown in both FIGS. 3A and 3B, in step S1, the consumer calls into the system and reaches the system's IVR 20. Optionally, the IVR detects the caller's mobile phone number at step S2 (e.g., via DNIS), along with additional other information, such as the telephone service provider the caller is using, the cell tower through which the call is routed, and other like information. Alternatively, the caller will supply that information to the system manually, e.g., via voice responses, via the internet, or the like. In any case, in step S3, IVR 20 prompts the caller for an ad code, and in step S4, the system determines if an ad code is provided.

The ad code can be typed on the phone keypad or may be spoken by the caller and recognized via voice recognition software. Additionally, the caller need not necessarily have to have seen or heard an ad or an ad code to use the invention. Rather, the caller might instead be thinking about a brand, product, or service, or the consumer may have seen the brand, product, or service itself while out and about. If the company that produces or sells that brand or product is a participating/subscribing member of the system, the system may recognize the company name or the name of the product in the same way it would recognize an ad code. As an example, a caller might not have seen a specific ad or associated ad code from Ford Motor Co., however she may see a model parked or driving on the street and immediately want more information about that vehicle. She can speak or type the word “Ford” or the word “Mustang” into the system. If either of those two words are valid codes, a message will be sent to the caller. Each subscribing advertiser/seller may be charged for each code it reserves, although the invention is not limited to any specific subscription fee arrangement.

As another option, the code enterable into the system (either by typing or by voice) need not be a brand or product name, but rather may be a generic noun or other descriptive word that is related to the product. Continuing with the above example, the caller might not know what make or model a car is that she sees on the street, but she may still want to follow up on purchasing a vehicle nonetheless. The system can easily be configured to accept “car”, “cars”, or “car dealer(s)” and send back an appropriate message. Should there be more than one subscribing car dealer, the message returned might include an instruction to the caller to request one of the subscribing businesses listed. As another alternative, the system can be configured to send the caller multiple messages, e.g., one message for each qualifying subscribing business (e.g., all subscribing car dealers). Fundamentally, any word, phrase, or alphanumeric string can be used as a code, especially for embodiments utilizing voice recognition.

In any event, if an ad code is provided, the logic proceeds to step S5, and IVR 20 sends the entered ad code and caller phone number (and other information, optionally) to the database server 30 via, for example, XML document 28. At step S6, software 38 on server 30 searches through advertiser content management database 32 to determine if the ad code entered is a valid code.

If the code is not recognized, the system may prompt the caller to re-enter the code one or several times. After one or more failed attempts to enter a valid ad code, the logic terminates at step S7, and the system hangs up on the caller.

If the entered ad code is recognized at step S6, then software 38 determines at step S8 if there are any restrictions associated with the ad code and its outgoing message, e.g., it should only be sent at certain times of the day, or only to mobile phones in a certain geographic region, or only to callers with certain demographic characteristics, or the like. If the advertiser has placed no restrictions on the outgoing message, then software instructs message server 40 to send the requested message 42 to the caller's mobile phone at step S9. Additionally, a record of that message being sent to that caller is logged in transaction log database 36 at step S10, and the process terminates at step S11. (Alternatively, the record logged in database 36 may include which message was sent or to which caller it was sent; both are preferred but not required).

If software 38 determines at step S8 that there are restrictions on the ad code, then software 38 will compare those restrictions to at least one of the information in XML document 28 (which may include mobile carrier and cell tower information, for example) or the demographic data associated with the mobile number. If demographic data needs to be reviewed, software 38 will look up such data in registration database 34 at step S12 and compare it to the message requirements in step S13. If the caller does not meet the demographic requirements (e.g., she is too young or lives in the wrong locale), the logic will terminate at step S14; the system may either send a message to the caller indicating that the desired information is unavailable or may simply not send any message at all. If, however, at step S13, software 38 determines that the caller meets the requirements, then the logic proceeds to step S9, the message is sent, and the transaction is logged in databse 36 in step S10 as above.

Returning to step S4, if an ad code is not provided, software 26 on IVR 20 may query the caller if he wishes to register his mobile phone with the system at step S15. (Alternatively, the system may initially provide for a single branching of logic, collapsing steps S4 and S15, e.g., “press or say 1 to enter an ad code, press or say 2 to register.”) If the caller does not wish to register, then the system hangs up at step S16. If the caller does wish to register and indicates as such with the requisite voice or push-button response, the system sends a registration text message to the caller's mobile phone at step S17. The registration text message will include at the very least an activatable link.

Thus far, the respective logic flows of FIGS. 3A and 3B have been identical. It is at this juncture where they differ. In FIG. 3A, when the caller activates the link in step S18, an applet is downloaded to the mobile phone that cause the system's phone access number to be stored in the phone and accessible by pressing the zero (0) button in step S19. On conventional land-line telephones, simply dialing 0 would connect the caller to an operator who could render assistance. On many mobile phones, the zero button is limited to a connection to the mobile carrier. In the case of some mobile phones (e.g., the LG enV²), the zero button serves not in a speed-dial capacity but rather to lock the keyboard and prevent accidental depression of the buttons; it thus serves to restrict access and connectivity rather than to enable access or connectivity. As such, by reprogramming the user's phone's zero button to provide one-touch access to the system, the invention provides significant additional functionality to the phone. Moreover, since there is typically no speed-dial zero position (speed-dial positions begin with 1 or 01, almost universally), there is no concern of erasing a previous speed-dial entry by programming the zero button in this manner. In this preferred embodiment, the logic flow finally ends at step S20, as shown in FIG. 3A.

In FIG. 3B, an optional feature is shown which allows the user to select a speed-dial position for the system's telephone access number. With this feature, the logic is as follows. When the caller activates the link in step S18, an applet is downloaded to the mobile phone that will cause the system's phone access number to be stored in a speed dial position on the phone (see step S19′). When the applet opens, it asks the caller to select a speed dial position for the system's telephone access number at step S20′. If the applet does not detect that the caller has made a selection (or has made an invalid selection) at step S21, the applet will shut off at step S22 (perhaps after several failed attempts). If a valid speed dial position is detected at step S21, the applet saves the access number at that position at step S23, and the applet deactivates at step S24. The mobile phone is now readily available for fully advantageous use of the inventive system. A caller may be directed at this point back to step S3, and a prompt for an ad code 14 may be proffered. Although this embodiment of the invention offers the caller/user an additional choice and ostensibly more flexibility in the assigning of the system's telephone access number, it has the potential to erase a previously programmed speed-dial number. It also allows for greater possibility that the user will not successfully program his phone at all, e.g., he will enter an invalid entry at step S21. As such, while offering greater potential personalization and functionality, this embodiment is less “idiot-proof” than the preferred embodiment.

FIG. 4 illustrates a section of the logic flow of the invention that corresponds to an embodiment in which the consumer also has a configurable profile. At some point following step S6 of FIG. 3, in which the ad code that is supplied to the system by the caller is recognized, the system looks up the messaging instructions associated with the identified caller's profile at step S25. These messaging instructions may include which of a plurality of communication devices the consumer is instructing the system to send the messages (mobile phone or phones, fax machine, e-mail, etc.) and in what format (text, voice, HTML, plain, etc.). Once the message instructions are retrieved, the system sends the message to the caller in accordance with the caller profile message instructions in step S9′ (in place of step S9 of FIG. 3). The logic returns to the previous flow, with the transaction being logged in the transaction database at step S10 and ending at step S11. This subroutine may be spliced into the FIG. 3 flow chart between steps S6 and S8, between steps S8 and S9, between steps S13 and S9, or in other similar locations.

While FIG. 4 depicts how the messages are to be routed in accordance with the consumer's preferences, FIG. 5 illustrates a further modification in which messages may be allowed or blocked. As before, the system looks up the messaging instructions associated with the identified caller's profile at step S25. Message parameters (e.g., content, advertiser identity, etc.) are compared to caller profile restrictions in step S26. If it is determined that the requested message meets the caller's requirements in step S27, then the message is sent to the caller via the caller's instructions in step S9′, the transaction is logged in step S10, and the logic terminates at step S11. If, however, it is determined that the requested message does not meet the caller's requirements in step S27 (e.g., blocked content, blacklisted advertiser, etc.), then the requested message is not sent, and the logic flow ends at step S28. Preferably (also at step S28), the caller may be sent a “blocked message” message, indicating that the message that would have been sent in response to the caller-entered ad code is one that the caller does not actually want, for the reasons mentioned above (otherwise, the caller would enter a code and get no response, leaving the caller to wonder if the system were functioning properly). Optionally, the system will return a message to the caller indicating the requested information from the specific advertiser/seller is not available, but will further suggest other ad codes or keywords that are associated with products/services similar to the one associated with the ad code that the caller initially supplied.

As described above, the inventive system provides consumers with an extremely convenient tool to obtain information on demand as they see public advertising, and provides that information in a format which they can review at a later time. It is also an excellent way for advertisers to track the efficacy of their public advertisements. Advertisers may access the system via interface 50 and, after logging onto home page 52, perform a number of functions remotely via computer 6 and the internet 7. For example, advertisers can remotely manage the message profiles stored in database 32 via content management system 54. There, the advertiser can change any or all of the parameters concerning how a given message is to be disseminated, as well as the content of the message itself (e.g., prices or rates can be raised or lowered, deadlines extended, photos or pictures revised, etc.). Additionally, advertisers can access transaction log 36 via the view log report function/page 58. Transactions are preferably stored with searchable data fields, so that an advertiser can sort the data concerning the requests driven by its ads in any number of ways (demographically, geographically, chronologically, etc.).

The invention is not limited to the above description. For example, it has been described above that the consumer may provide demographic data via the internet, via mail, in person, or over the telephone to an agent. However, it is also contemplated that the downloadable applet will obtain such information from the caller and transmit it back to the system, e.g., in a text message or the like. Also, the mobile phone user may choose to set the access telephone number manually using their phone's software that saves numbers as a one-touch preset speed dial, or as a hands-free voice dial, or the like. In the latter example, the invention is made even safer for users on the go, particularly for those driving or riding vehicles.

Additionally, although the word “advertiser” is used, the term is not meant to be limited to those engaging in the commerce of products or services. Governmental agencies seeking to disseminate information may participate as “advertisers.” As one example, an ad code on a train schedule can result in the schedule being text messaged to the caller's phone. As another example, a city department of health may provide the caller with information concerning quitting smoking or avoiding/treating certain diseases. As a further example, “advertisers” may be a single entity covering a defined location, e.g., an amusement park or a museum, in which a caller may receive messages about specific rides, attractions, or exhibits; or a movie theatre, from which a caller may receive messages concerning what is playing and/or coming soon. Thus, the term “advertiser” (and, in some places, “seller”) refers to any entity that subscribes to the inventive system.

It should also be understood that while the above description references the sending of “messages” or “text messages” to mobile phones, the messages are not limited to merely text. Such messages may include graphics, sound, and video components. Advertisers can use the messaging feature to not only inform consumers about their products but also to provide them with coupons, vouchers, and other similar incentives. Such coupons or vouchers may be readily personalized with a built-in code indicating to whom the message was originally sent. Thus, if a coupon or voucher were to be forwarded by the original recipient to other individuals (either registrants of the system or not), every time that coupon is used bearing the original recipient's code, an advertiser can be made aware of precisely who is virally spreading the news about the product or service. In this way (among others), registrants may be able to earn points, money, or other similar compensation. Alternatively, a link may be embedded in the original text message sent to the information requester that is otherwise trackable.

The system can be used to deliver (paid) premium content, such as music, video, or another digital property/asset, and can add the charges for same to the caller's mobile carrier bill. Revenue sharing between the system operator and the mobile carrier is to be expected.

Having described certain embodiments of the invention, it should be understood that the invention is not limited to the above description or the attached exemplary drawings. Rather, the scope of the invention is defined by the claims appearing hereinbelow and any equivalents thereof as would be appreciated by one of ordinary skill in the art.

What is claimed is:

1. A telephonic system of providing on-demand information relating to aggregated publicly detectable advertising over a mobile telecommunications network, comprising:
a plurality of different publicly detectable advertisements each having a different code associated therewith;
a central telephony system adapted to receive entry of said associated codes by a consumer via a mobile telecommunications device upon the consumer becoming aware of said associated code; and
at least one computer in communication with said central telephony system adapted to create a message transaction and send a message to the consumer's mobile telecommunications device in response to said code entered by the consumer being recognized by said central telephony system, said message corresponding to said entered code.

2. A system according to claim 1, wherein said plurality of advertisements represent different advertisers.

3. A system according to claim 1, wherein said central telephony system is an interactive voice response (IVR) system.

4. A system according to claim 1, further comprising software resident on said at least one computer and downloadable to the consumer's mobile telecommunications device, said software having an embedded link, said software adapted to program the consumer's mobile telecommunications device with a telephone access number for said central telephony system when said embedded link is activated.

5. A system according to claim 4, wherein said software is further adapted to program one of the consumer's mobile telecommunications device's speed-dial positions with said telephone access number.

6. A system according to claim 1, further comprising at least one database, including a transaction database in which said message transactions are recorded.

7. A system according to claim 6, wherein each of said message transactions comprises at least one of: which advertisement triggered said message transaction; personal information about the consumer who entered said code; other codes the consumer previously entered; time of day of said message transaction; or location of consumer when said code was entered.

8. A system according to claim 6, further comprising a plurality of message profiles resident on said at least one computer, each of said message profiles containing message instructions corresponding to respective of said codes enterable into the central telephony system, said message instructions concerning how said messages are sent to the consumers' mobile telecommunications devices.

9. A system according to claim 8, said system further comprising a remote interface adapted to enable advertisers of said plurality of advertisements to each remotely configure or modify its respective said message profiles, wherein at least one of said message profiles corresponds to each of said advertisers.

10. A system according to claim 9, wherein said message instructions include at least one of: content of said message; limiting a time period during which said message may be sent; or limiting to which consumers said message may be sent based on a consumer demographic parameter.

11. A system according to claim 10, said at least one computer further comprising an advertiser management database upon which said message profiles reside, said advertiser management database being accessible by said advertisers via said remote interface.

12. A system according to claim 11, said at least one computer further comprising at least one messaging server, in communication with said advertiser management database, adapted to forward a message to a consumer's telecommunications device in response to receipt of one of said codes by said central telephony system from said consumer's telecommunications device.

13. A system according to claim 11, said plurality of different publicly detectable advertisements further comprising a first plurality of a first advertisement and a second plurality of a second advertisement, wherein each of said first advertisements has a same first code associated therewith and each of said second advertisements has a same second code associated therewith.

14. A system according to claim 6, further comprising a plurality of consumer-configurable profiles resident on said at least one computer, each of said consumer-configurable profiles containing message instructions concerning how said messages are to be sent to the respective consumers.

15. A system according to claim 14, wherein said message instructions include at least one of i) to which of a plurality of communication devices the consumer is instructing said system to send said messages; ii) restricting receipt of said messages based on message content restrictions; iii) message format restrictions; iv) whitelisting certain advertisers; v) blacklisting certain advertisers; or vi) restricting receipt of said messages based on respective advertiser demographic parameters.

16. A system according to claim 15, wherein said plurality of communication devices includes at least one of a cell phone, a fax machine, an e-mail account, social networking pages, or micro-blogs.

17. A system according to claim 14, further comprising:
a registration database upon which said consumer-configurable profiles reside; and
a remote interface adapted to enable the consumers to each remotely configure or modify his/her respective of said consumer-configurable profiles, wherein at least one of said consumer-configurable profiles corresponds to each of the consumers.

18. A telephonic method of telephonically providing on-demand information relating to aggregated publicly detectable advertising via a mobile communications network, comprising the steps of:
for a plurality of different publicly detectable advertisements, associating a different code with each advertisement;
providing a central telephony system responsive to the entry of the associated codes by a consumer via a mobile telecommunications device upon the consumer becoming aware of the associated code;
creating a message transaction by sending a message to the consumer's mobile telecommunications device in response to the code entered by the consumer being recognized by the central telephony system, the message corresponding to the advertisement bearing the entered code.

19. A method according to claim 18, wherein the plurality of advertisements represent different advertisers.

20. A method according to claim 18, wherein the central telephony system is an interactive voice response (IVR) system.

21. A method according to claim 18, wherein the message sending step further comprises the step of sending a text or voice message to the mobile telecommunications device that sent the corresponding recognized code to the central telephony system.

22. A method according to claim 18, further comprising the step of providing a telephone access number for consumers to access the central telephony system and thereby enter a code.

23. A method according to claim 22, further comprising the step of automatically programming a consumer's mobile telecommunications device with the telephone access number in response to a consumer-initiated action.

24. A method according to claim 23, wherein said automatic programming step further comprises the steps of:
sending a text message to the mobile telecommunications device with an embedded link; and
downloading and executing an applet that programs the mobile telecommunications device with the telephone access number when the embedded link is activated.

25. A method according to claim 24, wherein said automatic programming step further comprises the step of programming one of the mobile telecommunications device's speed-dial positions with the telephone access number via the applet.

26. A method according to claim 25, wherein the applet programs at least one of a consumer-selectable speed-dial position or voice-dial setting with the telephone access number.

27. A method according to claim 18, further comprising the step of recording each message transaction in a transaction database, wherein each recorded message transaction includes at least an indication of which advertisement triggered the transaction.

28. A method according to claim 18, wherein said associating step further comprises at least one of the steps of:
displaying the code on or near an advertisement; or
generating an audible version of the code in association with an advertisement.

29. A method according to claim 24, wherein the consumer-initiated action comprises the step of initially calling the telephone access number via the consumer's mobile telecommunications device.

30. A method according to claim 24, wherein the consumer-initiated action comprises the step of requesting the text message with the embedded link via an internet-based interface.

31. A method according to claim 27, wherein the transaction recording step includes the step of recording at least one of: which advertisement triggered the transaction; personal information about the consumer who provided the code; other codes the consumer previously entered; time of day of the transaction; or location of consumer when the code was provided.

32. A method according to claim 27, further comprising the steps of enabling the advertisers of the plurality of advertisements to each remotely configure or modify a message profile which contains message instructions corresponding to each respective code enterable into the central telephony system, the message profiles being storable on a computer in communication with the central telephony system.

33. A method according to claim 32, said message profiles including instructions concerning the step of sending messages to the consumers' mobile telecommunications devices.

34. A method according to claim 33, wherein the message profile instructions include at least one of: message content; limiting a time period during which a message may be sent; or limiting to which consumers a message may be sent based on a consumer demographic parameter.

35. A method according to claim 18, further comprising the steps of enabling the consumers to each remotely configure or modify a message profile which contains message routing instructions, the message profiles being storable on a computer in communication with the central telephony system.

36. A method according to claim 35, said message profiles including instructions concerning the step of sending messages to the consumers' mobile telecommunications devices.

37. A method according to claim 36, wherein the message profile instructions include at least one of: of i) to which of a plurality of communication devices the consumer is instructing said system to send said messages; ii) restricting receipt of said messages based on message content restrictions; iii) message format restrictions; iv) whitelisting certain advertisers; v) blacklisting certain advertisers; or vi) restricting receipt of said messages based on respective advertiser demographic parameters.

38. A telephonic system of providing on-demand information relating to aggregated product/service branding over a mobile telecommunications network, comprising:
a plurality of different consumer products or services each having a different code associated therewith;
a central telephony system adapted to receive entry of said associated codes by a consumer via a mobile telecommunications device upon the consumer becoming aware of said associated code; and
at least one computer in communication with said central telephony system adapted to create a message transaction and send a message to the consumer's mobile telecommunications device in response to said code entered by the consumer being recognized by said central telephony system, said message corresponding to said entered code.

39. A system according to claim 38, wherein said codes comprise at least one of i) the respective names of said consumer products or services, or ii) respective generic words describing said consumer products or services.

40. A system according to claim 38, wherein said plurality of consumer products or services represent different sellers of said products or services.

41. A system according to claim 38, further comprising software resident on said at least one computer and downloadable to the consumer's mobile telecommunications device, said software having an embedded link, said software adapted to program the consumer's mobile telecommunications device with a telephone access number for said central telephony system when said embedded link is activated.

42. A system according to claim 38, further comprising at least one database, including a transaction database in which said message transactions are recorded.

43. A system according to claim 42, further comprising a plurality of message profiles resident on said at least one computer, each of said message profiles containing message instructions corresponding to respective of said codes enterable into the central telephony system, said message instructions concerning how said messages are sent to the consumers' mobile telecommunications devices.

44. A system according to claim 43, said system further comprising a remote interface adapted to enable sellers of said plurality of consumer products or services to each remotely configure or modify its respective said message profiles, wherein at least one of said message profiles corresponds to each of said sellers.

45. A system according to claim 44, wherein said message instructions include at least one of: content of said message; limiting a time period during which said message may be sent; or limiting to which consumers said message may be sent based on a consumer demographic parameter.

46. A system according to claim 42, further comprising a plurality of consumer-configurable profiles resident on said at least one computer, each of said consumer-configurable profiles containing message instructions concerning how said messages are to be sent to the respective consumers.

47. A system according to claim 46, wherein said message instructions include at least one of i) to which of a plurality of communication devices the consumer is instructing said system to send said messages; ii) restricting receipt of said messages based on message content restrictions; iii) message format restrictions; iv) whitelisting certain sellers; v) blacklisting certain sellers; or vi) restricting receipt of said messages based on respective seller demographic parameters.

48. A telephonic method of telephonically providing on-demand information relating to aggregated product branding via a mobile communications network, comprising the steps of:
for a plurality of different consumer products or services, associating a different code with each product or service;
providing a central telephony system responsive to the entry of the associated codes by a consumer via a mobile telecommunications device upon the consumer desiring information concerning a product or service;
creating a message transaction by sending a message to the consumer's mobile telecommunications device in response to the code entered by the consumer being recognized by the central telephony system, the message corresponding to the product or service associated with the entered code.

49. A method according to claim 48, wherein the codes comprise at least one of i) the respective names of the consumer products or services, or ii) respective generic words describing the consumer products or services.

50. A method according to claim 48, wherein the message sending step further comprises the step of sending a text or voice message to the mobile telecommunications device that sent the corresponding recognized code to the central telephony system.

51. A method according to claim 48, further comprising the step of providing a telephone access number for consumers to access the central telephony system and thereby enter a code.

52. A method according to claim 51, further comprising the step of automatically programming a consumer's mobile telecommunications device with the telephone access number in response to a consumer-initiated action.

53. A method according to claim 52, wherein said automatic programming step further comprises the steps of:
sending a text message to the mobile telecommunications device with an embedded link; and
downloading and executing an applet that programs the mobile telecommunications device with the telephone access number when the embedded link is activated.

54. A method according to claim 48, further comprising the step of recording each message transaction in a transaction database, wherein each recorded message transaction includes at least an indication of which code triggered the transaction.

55. A method according to claim 54, wherein the transaction recording step includes the step of recording at least one of: which code triggered the transaction; personal information about the consumer who provided the code; other codes the consumer previously entered; time of day of the transaction; or location of consumer when the code was provided.

56. A method according to claim 54, further comprising the steps of enabling the sellers of the plurality of consumer products and services to each remotely configure or modify a message profile which contains message instructions corresponding to each respective code enterable into the central telephony system, the message profiles being storable on a computer in communication with the central telephony system.

57. A method according to claim 56, said message profiles including instructions concerning the step of sending messages to the consumers' mobile telecommunications devices, wherein the message profile instructions include at least one of: message content; limiting a time period during which a message may be sent; or limiting to which consumers a message may be sent based on a consumer demographic parameter.
